(19) United States
(12) Patent Application Publication
(10) Pub. No.: US 2023/0129200 A1
(43) Pub. Date: Apr. 27, 2023

(54) SYSTEM, APPARATUS AND METHODS FOR OFFLOADING DEBUG OPERATIONS FROM HOST TO PEER

(71) Applicants: Enrico D. Carrieri, Placerville, CA (US); Aruni Nelson, Folsom, CA (US)

(72) Inventors: Enrico D. Carrieri, Placerville, CA (US); Aruni Nelson, Folsom, CA (US)

(21) Appl. No.: 18/069,252

(22) Filed: Dec. 21, 2022

(51) Int. Cl. G06F 11/36; G06F 13/40

(52) U.S. Cl. CPC G06F 11/362; G06F 13/4022; G06F 2213/0026

(57) ABSTRACT

In one embodiment, a host processor includes a configuration circuit that, in response to identification of a first device capable of debugging a second device, is to configure a switch to enable device-to-device messaging between the first device and the second device, the device-to-device messaging comprising at least one of debug messaging or test messaging to be communicated without host processor involvement. Other embodiments are described and claimed.

### BACKGROUND

Computer systems often need to be debugged or tested to determine a source of errors, malfunctions or so forth. In typical systems, a host of the system (e.g., a central processing unit (CPU)) is involved in such debug or testing of connected devices such as Peripheral Component Interconnect Express (PCIe) or Compute Express Link (CXL) devices. This host is used to send any debug messages and receive any relevant debug data or register values. This involvement can require heavy CPU usage in cases where a debug scenario incurs constant monitoring, which exponentially increases with setups incurred in servers. In addition, the debugging or testing increases traffic along functional paths, and can perturb normal system operation in a manner that can adversely impact fidelity of testing or debugging.

### BRIEF DESCRIPTION OF THE DRAWINGS

FIG. 1A is a block diagram of a system in accordance with an embodiment.

FIG. 1B is a block diagram of a system in accordance with another embodiment.

FIG. 2 is a flow diagram of a method in accordance with an embodiment.

FIG. 3A is a graphical illustration of a PCIe extended configuration space for debug offload capabilities in accordance with an embodiment.

FIG. 3B is a graphical illustration of a first debug packet in accordance with an embodiment.

FIG. 3C is a graphical illustration of a second debug packet in accordance with an embodiment.

FIG. 4 is an embodiment of a fabric composed of point-to-point links that interconnect a set of components.

### DETAILED DESCRIPTION

In various embodiments, a system is configured to perform debugging and testing of peripheral devices (e.g., CXL and PCIe devices) without host intervention. To this end, a switch provides a communication path between connected devices for debug and test communications without involvement of a host processor, thus offloading debug and test activity from the host processor. More particularly, a first connected device can be configured to include debug and/or test circuitry (herein, the terms “debug” and “test” each may be used to refer to both or either of debug and test operations) and to be a controller for debug or test operations. In turn, a second connected device can be a device under test. Via the switch, transmission of debug messages, commands, and data for debugging or testing of CXL or PCIe devices by another PCIe (or CXL) device can occur.

Embodiments may be used to offload debugging and testing of any internally or externally connected high bandwidth CXL or PCIe devices, including discrete CXL/PCIe devices from external vendors. With embodiments, there is reduced use of CPU processing and host resources to debug and test any such devices. Embodiments may further provide a mechanism for preemptive error correction via smart and robust CXL and PCIe functionality monitoring, leading to improved user experience.

In one or more embodiments, certain debug and test messages can be used to perform any security messages and token exchanges for authentication of the devices to securely communicate, e.g., using Security Protocol and Data Model (SPDM) per a Distributed Management Task Force (DMTF) specification (https://www.dmtf.org/dsp/DSP0274). In this way, secure communication of debug/test messages, commands and data for debugging or testing of a peer device by another peer device occurs without host involvement. In one or more embodiments, such messages, commands and data can be sent using Vendor Defined Messages (VDMs).

Although not limited in this regard, embodiments may be used for debug and test situations for high bandwidth devices in client and server platforms such as: run control; trace messages from a device under test/debug; monitoring of device functionality to preemptively take corrective or recovery actions; and/or replicating relevant data sent and received by the device for post-testing analysis. In one or more embodiments, the device having control debug capability may be configured to store responses from the device under test/debug locally, on another device in a system, another host system or a secure cloud storage

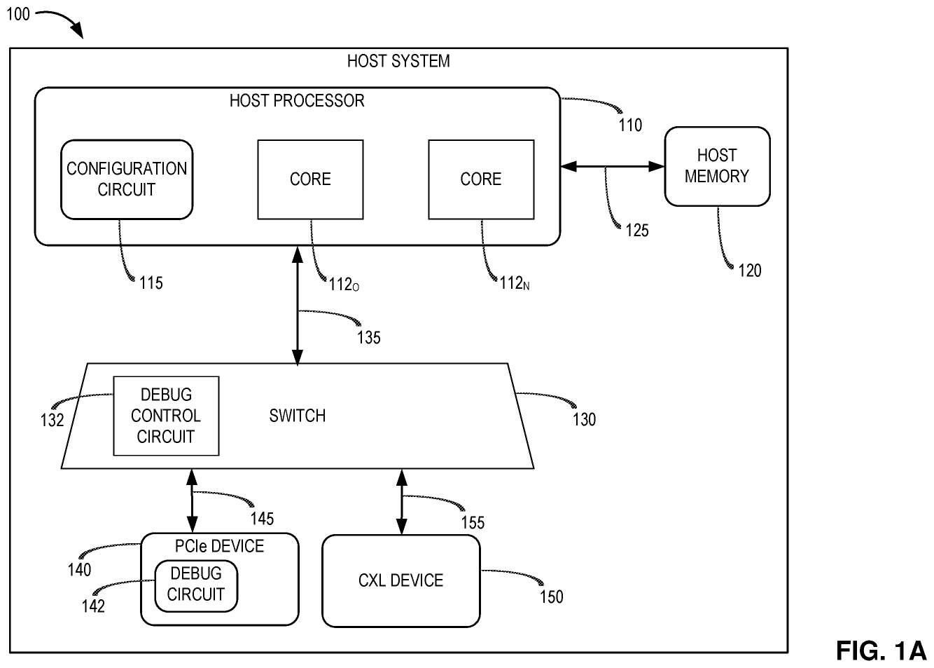

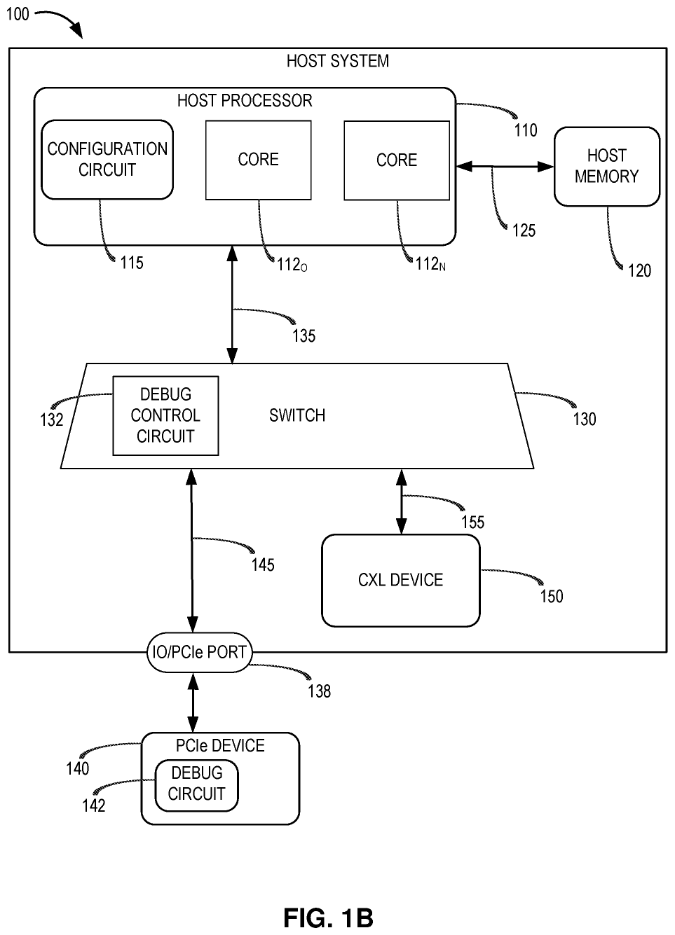

Referring now to FIG. 1A, shown is a block diagram of a system in accordance with an embodiment. As shown in FIG. 1A, system 100 may be any type of computing device, ranging from small portable devices such as smartphones, tablet computers and so forth, to larger devices including laptop computers, desktop computers or other client devices, and even larger devices such as server systems or other cloud-based computing devices. In the high level shown in FIG. 1A, system 100 provides capabilities in accordance with an embodiment to offload debug and test processing and communication away from a host processor. In this way, unwanted consumption of host resources and perturbation of system operation can be avoided.

As shown in FIG. 1A, system 100 includes a host processor 110. Host processor 110 may be a main CPU and may include a plurality of cores 112₀-_{N}. In different implementations, cores 112 may be homogenous or heterogenous cores. Although embodiments are not limited in this regard, in one implementation host processor 110 may be a system on chip (SoC) adapted within a single semiconductor package that includes one or more semiconductor dies.

As further illustrated, host processor 110 includes a configuration circuit 115. In embodiments herein, configuration circuit 115 configures circuitry both internally and externally to host processor 110. In particular embodiments herein, configuration circuit 115 is configured to offload debug processing and communication to peripheral devices. In the example of FIG. 1A, more particularly, configuration circuit 115 may enable a first peripheral device, namely a PCIe device 140, to perform debugging operations on behalf of a device under test, namely another peripheral device, shown in FIG. 1A as a CXL device 150. This is so, as logic circuitry in both configuration circuit 115 and PCIe device 140 is present for this configurability.

Although shown at a high level in FIG. 1A, understand that host processor 110 further includes additional circuitry such as one or more accelerator devices (e.g., graphics processing units (GPUs)), or interface circuitry, a power controller, a memory controller and so forth.

Host processor 110 couples to a host memory 120 (which in an embodiment may be implemented as dynamic random access memory (DRAM)) via a memory interconnect 125. Host processor 110 further communicates with additional components via a switch 130. In various embodiments, switch 130 may be implemented as a programmable PCIe switch that is configured to provide host-transparent communication between peripheral devices. To this end, switch 130 may include a debug control circuit 132 that is configured to set up and control debug communications between PCIe device 140 and CXL device 150. As shown, switch 130 couples to host processor 110 via an interconnect 135. Interconnect 135 may be a die-to-die (D2D) interconnect when switch 130 is implemented in a common package with host processor 110. In other embodiments, interconnect 135 can be implemented as a PCIe or other link. In turn, switch 130 couples to PCIe device 140 via a PCIe interconnect 145 and couples to CXL device 150 via a CXL link 155.

In the embodiment of FIG. 1A, PCIe device 140 is configured as a debug controller, in that it includes a debug circuit 142. In one example, PCIe device 140 may be implemented as a debug card. Debug circuit 142 may be configured to initiate and control debugging of CXL device 150. To this end, debug circuit 142 may include control circuitry, buffer circuitry and processing circuitry. Depending upon implementation, debug circuit 142 may initiate a debug operation, receive and buffer debug information such as tracing information, and also process the information, and possibly take corrective action based on the processed information.

In an embodiment, PCIe device 140 and CXL device 150 may have capability information stored in corresponding capability structures (which may be in accordance with an extension to a PCIe capability structure) to indicate the debug and test offload capabilities of the debugging and debug-able device.

In one or more embodiments, PCIe device 140 may be implemented as a debug and test system (DTS). In other cases, debug circuit 142 may trigger debugging and buffer debug information, which it may later provide to an external debugger, such as an external DTS. CXL device 150 may be any type of peripheral device such as an accelerator device, storage, memory or so forth. When controlled by PCIe device 140 for debug operation, CXL device 150 may provide trace or other debug information, via switch 130 to PCIe device 140.

As shown in FIG. 1A, configuration circuit 115 may configure switch 130 for appropriate test and debug operation. To this end, switch 130 may be configured to enable device-to-device messaging between PCIe device 140 and CXL device 150 for debugging and testing. Similarly, PCIe device 140 may be configured to enable receipt of such device-to-device messaging of debugging and testing information. In different implementations, this information may be sent via a mainband or a sideband of a link (such as where the PCIe/CXL links may not be available, not working, and/or are the thing that is being debugged). Note also that switch 130 can have multiple device-to-device debug sessions occurring concurrently.

In another implementation, switch 130 can be programmed by PCIe device 140 to perform the secure routing and managing of debug and test messages and data between PCIe device 140 and CXL device 150. In one or more embodiments, debug circuit 142 may be configured to send debug or test messages, commands and/or data to device 150. In addition, debug circuit 142 can monitor the behavior of device 150 to proactively initiate any recovery or corrective actions, based at least in part on data monitoring and analysis

Although shown at this high level in the embodiment of FIG. 1A, understand that variations and alternatives are possible. For example, in other cases it is possible for a CXL device to include debug circuitry to be used for managing debugging of a PCIe or CXL device. Furthermore, while PCIe device 140 and CXL device 150 are shown as being internal to system 100, embodiments are not so limited. In other implementations, one or both of these devices may be externally coupled to system 100. In addition, PCIe device 140 may debug multiple devices besides CXL device 150, allowing a single device to debug multiple devices. For example, there could be a single device monitoring the other devices for when a failure may occur.

Referring now to FIG. 1B, shown is a block diagram of a system in accordance with another embodiment. In FIG. 1B, system 100′ is implemented the same as in FIG. 1A; however, PCIe device 140 is an external device, such as a standalone debug and test system (DTS). In addition, an input/output (I/O)/PCIe interface (port) 138 is interposed between PCIe device 140 and switch 130. In other aspects, system 100′ is implemented the same as in FIG. 1A.

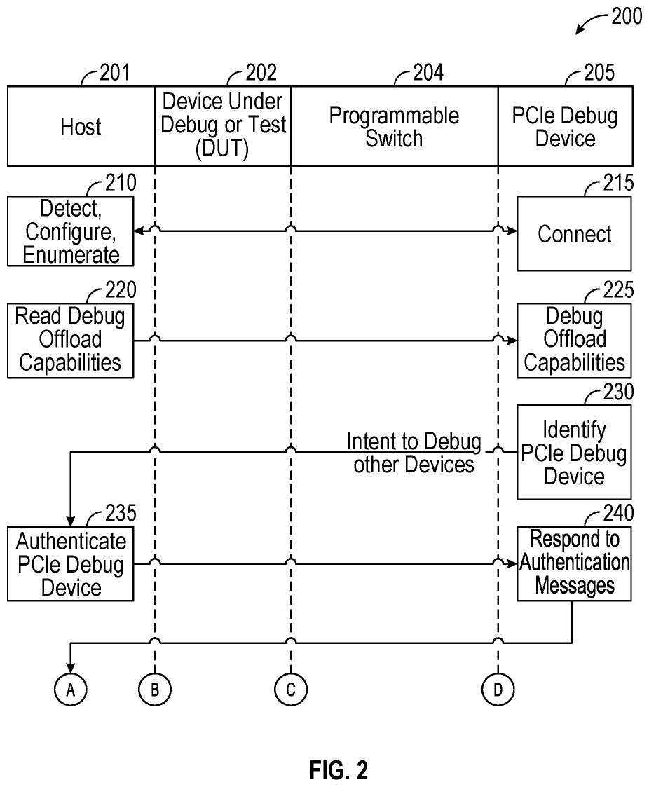

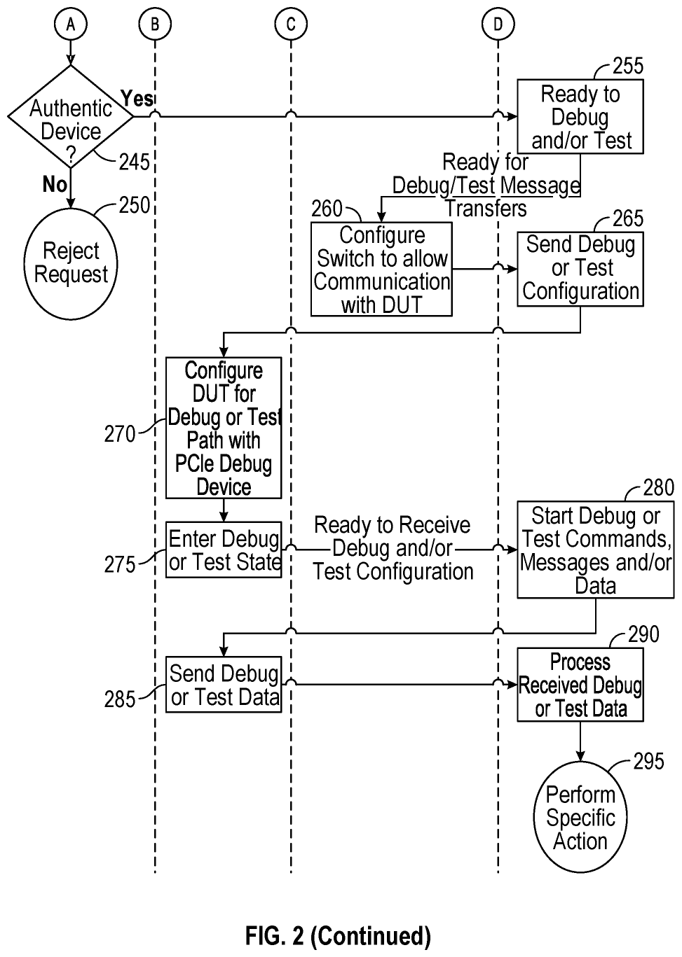

Referring now to FIG. 2, shown is a flow diagram illustrating connection, configuration and programming of a PCIe device capable of debug control in a system having one or more PCIe and/or CXL devices. More specifically as shown in FIG. 2, a system 200 includes a host 201 which may be a host processor of the system (or an entire host system) that couples to a device 202 that may be a CXL or PCIe device that is to be debugged or tested (a device under debug or test, DUT). In addition, a programmable switch 204 interfaces to both device 202 and a PCIe device 205 having debug control capabilities via included debug circuitry.

In this system, when device 205 is connected, host 201 may perform a detection, configuration and enumeration process 210 in which bidirectional communications occur, leading to a connect process 215.

Thereafter at block 220, the host device performs a read operation to determine capabilities of device 205. At this point, device 205 is enumerated and advertises its capabilities, including indicating its capabilities to debug and test peer devices. Thus of note here, these capabilities include debug offload capabilities as identified by the PCIe device at block 225. In one or more embodiments, such information may be obtained from a capability structure of the PCIe device. Next at block 230, PCIe device 205 indicates an intention for performing a device-to-device debug operation. Understand although shown as being initiated by PCIe device 205, in other cases, based on the capability information provided, host 201 itself may instruct the PCIe device for this debug operation. Next, at block 235, the host may authenticate the PCIe device by sending one or more authentication messages that the PCIe device responds to (at block 240). If authentication is successful (as determined at diamond 245), control passes to block 255 where the PCIe device is configured to be ready to debug and/or test. Otherwise if authentication is not successful, the request for performing debug may be rejected (block 250).

Still referring to FIG. 2, at block 260, programmable switch 204 may be configured to enable the device-to-device communication between device 202 (which is a device under debug or test) and PCIe device 205. This configures a communication path that is directed and managed by switch 204 over which messages for configuration and message/command and data exchange between device 205 and device 202 can be transmitted. This configuration may be performed by host 201 or PCIe device 205 depending on implementation.

After such switch configuration, at block 265, PCIe device 205 sends a debug or test configuration to DUT 202, for performing debugging or testing and enabling a communication path between the two devices (block 270). Thereafter at block 275, DUT 202 may enter a debug or test state (block 275). Once DUT 202 is in this state, at block 280, PCIe device 205 may start sending debug or test commands/messages and/or data, which causes a given debug or testing operation to be performed within DUT 202. Results of this debug or test operation may then be sent as debug or test data (in block 285).

Then at block 290, PCIe device 205 may process the received debug or test data. Depending upon implementation, various processing such as decoding/analysis of trace or log messages may be performed. Other example processing may include updating a variable value to get desired results, monitoring a certain variable, replicating functional traffic for post processing, storing responses from DUT 202 locally, on another host system or secure cloud space. Thereafter, depending upon the results, some specific action may be performed (block 295). For example, additional status registers could be read, the test setup could be changed and the test/scenario re-executed. Other example operations may include issuing a certain test pattern to observe the behavior of a system, issuing a reset to recover a failed system based on debug/test response, and/or performing a corrective action on DUT 202. Understand while shown at this high level in the embodiment of FIG. 2, many variations and alternatives are possible.

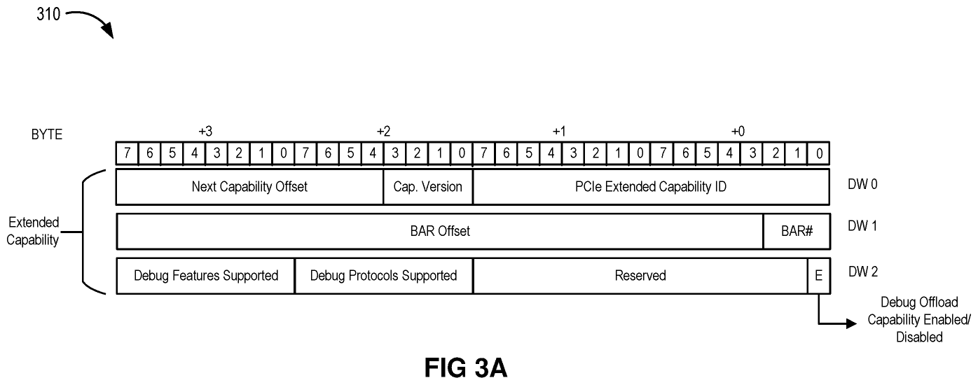

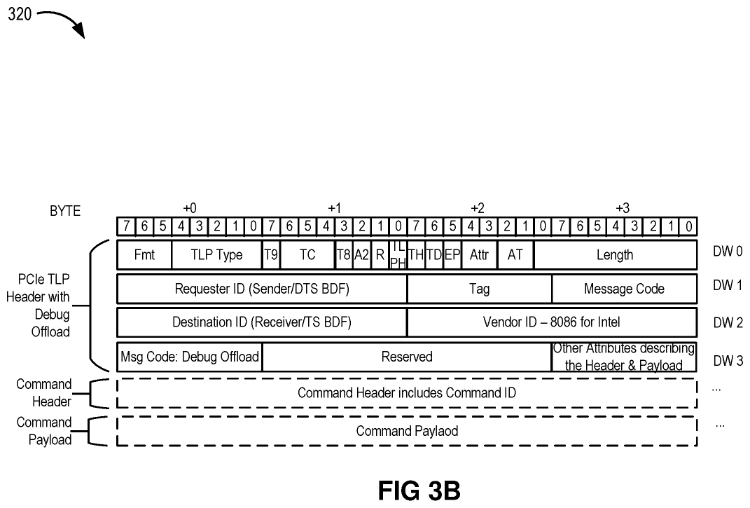

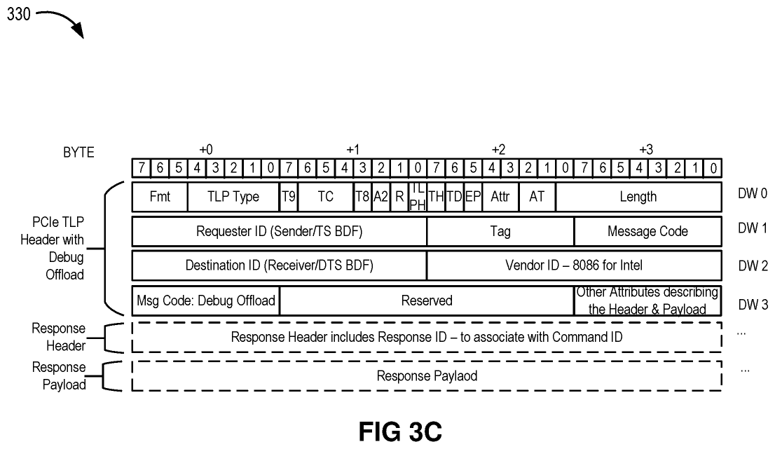

Referring now to FIG. 3A, shown is a graphical illustration of a PCIe extended configuration space for debug offload capabilities in accordance with an embodiment. More specifically, in FIG. 3A a capability configuration space 310 is shown in which a peripheral device can indicate a capability to perform debug and/or test as a debug offload agent in accordance with an embodiment. As shown capability configuration space 310 is implemented as per PCIe standard specification which can be accessed by PCI Express Enhanced Configuration Access Mechanism (ECAM), which includes PCI-defined information, capability offset and ID information, a base address register (BAR) offset, and debug capability information, including debug features supported (e.g., run-control, logging, replicating functional traffic, initiating and sending test patterns, etc.), debug protocols supported (e.g., vendor defined protocols, industry standard debug protocols such as defined by MIPI, JTAG, etc.), and an enable indicator to indicate whether the debug offload capability is enabled (when set) or disabled (when reset). This indicator may indicate the protocol of the trace (e.g., MIPI STP), if run-control capabilities are supported, and provide discovery information to indicate the version of the debug capabilities for the tooling.

Referring now to FIG. 3B, shown is a graphical illustration of a first PCIe debug packet in accordance with an embodiment. More specifically, in FIG. 3B a debug command packet 320 is shown in which a peripheral device having debug offset capability can send a debug command to a peer device to cause it to perform debug and/or test. As shown command packet 320 is implemented as a PCIe transaction layer packet (e.g., VDM) including PCIe header information including a debug offset message code, along with a command header (that includes a command ID) and a command payload, which may include one or more commands and/or data directed to a peer device. As examples, the commands could include setting and reading registers/configurations; run-control commands such as GO, HALT, and breakpoints; performing data extractions (e.g., logs, trace messages), among others.

Referring now to FIG. 3C, shown is a graphical illustration of a second PCIe debug packet in accordance with an embodiment. More specifically, in FIG. 3C a debug response packet 330 is shown that a peripheral device can send to a debug control (e.g., a peer device having debug offload capability). As shown response packet 330 is implemented as a PCIe transaction layer packet (e.g., VDM) including PCIe header information including a debug offset message code, along with a response header (that includes a response ID to be associated with a corresponding command ID of given debug command) and a response payload, which may include debug data directed to a peer device. As examples, the responses may include status/state information, register data (from reads), logs, trace data and so forth.

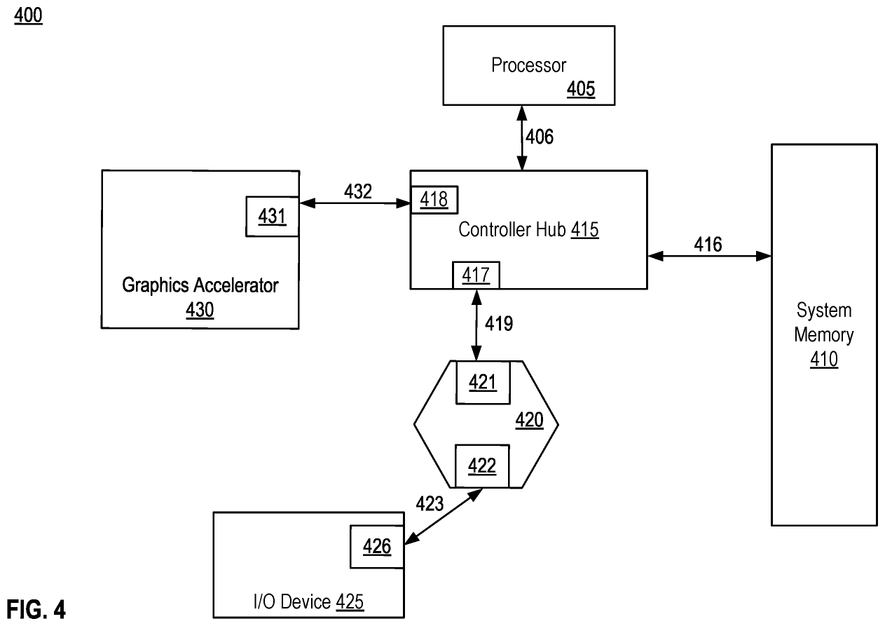

Embodiments may be implemented in a wide variety of systems. Referring to FIG. 4, an embodiment of a fabric composed of point-to-point links that interconnect a set of components is illustrated. System 400 includes processor 405 and system memory 410 coupled to controller hub 415. Processor 405 includes any processing element, such as a microprocessor, a host processor, an embedded processor, a co-processor, or other processor. Processor 405 is coupled to controller hub 415 through a link 406, such as an Intel® Ultra Path Interconnect (UPI) serial point-to-point interconnect.

System memory 410 includes any memory device, such as random access memory (RAM), non-volatile (NV) memory, or other memory accessible by devices in system 400. System memory 410 is coupled to controller hub 415 through memory interface 416. Examples of a memory interface include a double-data rate (DDR) memory interface, a dual-channel DDR memory interface, and a dynamic RAM (DRAM) memory interface.

In one embodiment, controller hub 415 is a root hub, root complex, or root controller in a PCIe interconnection hierarchy. Examples of controller hub 415 include a chipset, a memory controller hub (MCH), a northbridge, an interconnect controller hub (ICH), a southbridge, and a root controller/hub. Often the term chipset refers to two physically separate controller hubs, e.g., a memory controller hub (MCH) coupled to an interconnect controller hub (ICH). Note that current systems often include the MCH integrated with processor 405, while controller 415 is to communicate with I/O devices, in a similar manner as described below. In some embodiments, peer-to-peer routing is optionally supported through root complex 415.

Here, controller hub 415 is coupled to a switch 420 through serial link 419. Input/output modules 417 and 421, which may also be referred to as interfaces/ports 417 and 421, include/implement a layered protocol stack to provide communication between controller hub 415 and switch 420. In one embodiment, multiple devices are capable of being coupled to switch 420. Switch 420 couples to a device 425 through an interconnect 423 (e.g., a PCIe and/or CXL link) via corresponding interfaces/ports 422 and 426.

Switch 420 routes packets/messages from device 425 upstream, i.e., up a hierarchy towards a root complex, to controller hub 415 and downstream, i.e., down a hierarchy away from a root controller, from processor 405 or system memory 410 to device 425. Device 425 may be a PCIe debug device in accordance with an embodiment.

Graphics accelerator 430 is also coupled to controller hub 415 through serial link 432. In one embodiment, graphics accelerator 430 is coupled to an MCH, which is coupled to an ICH. In other embodiments, graphics accelerator 430 may be an I/O device, a NIC, an add-in card, an audio processor, a network processor, a memory expander, a hard-drive, a storage device such as a solid state drive, a printer, a mouse, a keyboard, a router, a portable storage device, or so forth. I/O modules 431 and 418 are also to implement a layered protocol stack to communicate between graphics accelerator 430 and controller hub 415. A graphics controller or the graphics accelerator 430 itself may be integrated in processor 405.

With embodiments, switch 425 is configured to perform peer-to-peer routing of debug communications between graphics accelerator 430 and device 425 as described herein.

The following examples pertain to further embodiments.

In one example, a host processor comprises: at least one core to execute instructions; and a configuration circuit coupled to the at least one core. The configuration circuit: in response to identification of a first device capable of debugging a second device, is to configure a switch to enable device-to-device messaging between the first device and the second device, the device-to-device messaging comprising at least one of debug messaging or test messaging.

In an example, via the configuration of the switch, the host processor is to offload to the first device at least one of debug or test of the second device.

In an example, the host processor is to execute a first workload during the debug or the test of the second device, the debug or the test of the second device independent of the first workload.

In an example, the host processor is to authenticate the first device and in response to authentication of the first device, the configuration circuit is to configure the switch to enable the device-to-device messaging.

In an example, the host processor is to read capability information of the first device, the capability information comprising a debug control capability.

In an example, the configuration circuit is to configure the switch to enable the device-to-device messaging based at least in part on the debug control capability.

In an example, the host processor is to read the capability information present in at least one transaction layer packet, the transaction layer packet comprising a vendor defined message comprising a debug offload indicator to indicate that the first device is enabled to be a debug controller.

In an example, the configuration circuit is to configure the switch to enable the device-to-device messaging via a sideband link coupled between the host processor and the switch, wherein the switch is to couple to the host processor via a PCIe link.

In another example, a method comprises: receiving, in a switch coupled to a first device, a second device, and a host processor, a configuration message to enable device-to-device messaging between the first device and the second device; receiving, from the first device, a debug command message and providing at least a portion of the debug command message to the second device to cause the second device to enter into a debug mode; and communicating debug traffic between the first device and the second device and not communicating the debug traffic to the host processor.

In an example, the method further comprises receiving, in the switch, the configuration message from the host processor.

In an example, the method further comprises receiving, in the switch, the configuration message from the host processor, in response to the host processor authenticating in the first device as a debug controller.

In an example, the method further comprises receiving, in the switch, the configuration message from the first device, the first device comprising a first PCIe device and the second device comprising a second PCIe device or a CXL device.

In an example, the method further comprises receiving, in the switch, capability information from the first device, the capability information to indicate a debug offload capability of the first device.

In an example, the method further comprises receiving, in the switch, the capability information from the first device, the capability information further to indicate one or more supported debug features and one or more supported debug protocols.

In an example, the method further comprises receiving, in the switch, debug data from the second device and sending the debug data to the first device via the switch and without involvement of the host processor.

In an example, the method further comprises processing the debug data in the first device, the first device comprising a debug and test system coupled to the switch via a PCIe link.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises: a host processor comprising one or more cores; a switch coupled to the host processor; a first device coupled to the switch, the first device comprising a debug circuit to operate as a debug controller; and a second device coupled to the switch, where the debug circuit is to debug the second device via device-to-device messaging communicated between the first device and the second device through the switch, without involvement of the host processor.

In an example, the switch is to communicate a debug message comprising at least one PCIe packet comprising the debug message, the debug message of a debug protocol and wrapped within the at least one PCIe packet.

In an example, the first device is to debug a plurality of devices.

In an example, the first device is to send a debug command to the second device via the switch, the debug command comprising a PCIe packet including a header indication of a debug offload and command information.

In an example, the second device is to send a debug response to the first device via the switch, the debug response comprising another PCIe packet including the header indication of the debug offload and a payload comprising debug data.

In an example, the switch is to engage in a plurality of device-to-device debug sessions concurrently.

In yet another example, an apparatus comprises: means for receiving a configuration message for enabling device-to-device messaging between a first device and a second device; means for receiving, from the first device, a debug command message and means for providing at least a portion of the debug command message to the second device for causing the second device to enter into a debug mode; and means for communicating debug traffic between the first device and the second device directly without interposition of a host processing means.

In an example, the apparatus further comprises means for receiving the configuration message from the host processing means.

In an example, the apparatus further comprises means for receiving the configuration message from the host processing means in response to the host processing means authenticating in the first device as a debug controller.

In an example, the apparatus further comprises means for receiving the configuration message from the first device, the first device comprising a first PCIe device and the second device comprising a second PCIe device or a CXL device.

In an example, the apparatus further comprises means for receiving capability information from the first device, the capability information for indicating a debug offload capability of the first device.

In an example, the apparatus further comprises means for receiving the capability information from the first device, the capability information further for indicating one or more supported debug features and one or more supported debug protocols.

In an example, the apparatus further comprises means for receiving debug data from the second device and means for sending the debug data to the first device via a switch means without involvement of the host processing means.

In an example, the apparatus further comprises means for processing the debug data in the first device, the first device comprising a debug and test system coupled to the switch means via a PCIe link means.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A host processor comprising:
at least one core to execute instructions; and
a configuration circuit coupled to the at least one core, wherein the configuration circuit:
in response to identification of a first device capable of debugging a second device, is to configure a switch to enable device-to-device messaging between the first device and the second device, the device-to-device messaging comprising at least one of debug messaging or test messaging.

2. The host processor of claim 1, wherein via the configuration of the switch, the host processor is to offload to the first device at least one of debug or test of the second device.

3. The host processor of claim 2, wherein the host processor is to execute a first workload during the debug or the test of the second device, the debug or the test of the second device independent of the first workload.

4. The host processor of claim 1, wherein the host processor is to authenticate the first device and in response to authentication of the first device, the configuration circuit is to configure the switch to enable the device-to-device messaging.

5. The host processor of claim 1, wherein the host processor is to read capability information of the first device, the capability information comprising a debug control capability.

6. The host processor of claim 5, wherein the configuration circuit is to configure the switch to enable the device-to-device messaging based at least in part on the debug control capability.

7. The host processor of claim 5, wherein the host processor is to read the capability information present in at least one transaction layer packet, the transaction layer packet comprising a vendor defined message comprising a debug offload indicator to indicate that the first device is enabled to be a debug controller.

8. The host processor of claim 1, wherein the configuration circuit is to configure the switch to enable the device-to-device messaging via a sideband link coupled between the host processor and the switch, wherein the switch is to couple to the host processor via a Peripheral Component Interconnect Express (PCIe) link.

9. A method comprising:
receiving, in a switch coupled to a first device, a second device, and a host processor, a configuration message to enable device-to-device messaging between the first device and the second device;
receiving, from the first device, a debug command message and providing at least a portion of the debug command message to the second device to cause the second device to enter into a debug mode; and
communicating debug traffic between the first device and the second device and not communicating the debug traffic to the host processor.

10. The method of claim 9, further comprising receiving, in the switch, the configuration message from the host processor.

11. The method of claim 9, further comprising receiving, in the switch, the configuration message from the host processor, in response to the host processor authenticating in the first device as a debug controller.

12. The method of claim 9, further comprising receiving, in the switch, the configuration message from the first device, the first device comprising a first Peripheral Component Interconnect Express (PCIe) device and the second device comprising a second PCIe device or a Compute Express Link (CXL) device.

13. The method of claim 12, further comprising receiving, in the switch, capability information from the first device, the capability information to indicate a debug offload capability of the first device.

14. The method of claim 13, further comprising receiving, in the switch, the capability information from the first device, the capability information further to indicate one or more supported debug features and one or more supported debug protocols.

15. The method of claim 9, further comprising receiving, in the switch, debug data from the second device and sending the debug data to the first device via the switch and without involvement of the host processor.

16. A system comprising:
a host processor comprising one or more cores;
a switch coupled to the host processor;
a first device coupled to the switch, the first device comprising a debug circuit to operate as a debug controller; and
a second device coupled to the switch, wherein the debug circuit is to debug the second device via device-to-device messaging communicated between the first device and the second device through the switch, without involvement of the host processor.

17. The system of claim 16, wherein the switch is to communicate a debug message comprising at least one Peripheral Component Interconnect Express (PCIe) packet comprising the debug message, the debug message of a debug protocol and wrapped within the at least one PCIe packet.

18. The system of claim 16, wherein the first device is to send a debug command to the second device via the switch, the debug command comprising a Peripheral Component Interconnect Express (PCIe) packet including a header indication of a debug offload and command information.

19. The system of claim 18, wherein the second device is to send a debug response to the first device via the switch, the debug response comprising another PCIe packet including the header indication of the debug offload and a payload comprising debug data.

20. The system of claim 16, wherein the switch is to engage in a plurality of device-to-device debug sessions concurrently.
